(19) United States
(12) Patent Application Publication
(10) Pub. No.: US 2005/0165869 A1
(43) Pub. Date: Jul. 28, 2005

(54) Backup system

(76) Inventors: Jason C. J. Huang, Taipei (TW); Jong-Min Deng, Taipei (TW)

Correspondence Address: Cynthia L. Pillote;Snell & Wilmer L.L.P., One Arizona Center, 400 East Van Buren, Phoenix, AZ, 85004-2202, US

(21) Appl. No.: 10/927,361

(22) Filed: Aug. 26, 2004

(30) Foreign Application Priority Data
Aug. 29, 2003 (TW) 92123911

(51) Int. Cl. G06F 12/00

(52) U.S. Cl. 707/204

(57) ABSTRACT

A backup system backs up information of mobile devices via wireless communication. The backup system includes a first mobile terminal, a backup server, and a transmission module. The first mobile terminal includes a first storage module for storing first information and a detection module. The backup server includes a server storage module for storing server information and a server detection module. The transmission module provides data transmission between the first mobile terminal and the backup server. Through the transmission module, a copy of first information is uploaded to the backup server as the server information, or a copy of server information is downloaded to the first mobile terminal as the first information.

### CROSS-REFERENCE TO RELATED APPLICATION

This application claims priority of Taiwan Patent Application Serial No. 092123911 filed on Aug. 29, 2003.

### FIELD OF INVENTION

The present invention relates to a backup system. Particularly, the present invention relates to a backup system for backing up information for mobile devices via wireless communication.

### BACKGROUND OF THE INVENTION

Mobile communication devices are becoming ever more powerful. For example, to process information of phone calls, a mobile phone provides a directory of phone numbers and a calling track list. Besides, almost all mobile phones nowadays support short message services (SMS).

The Smart-phone is popular as it combines the functions of the mobile phone and the personal digital assistant (PDA). The third generation (3G) protocol provides a platform for data communication in high transmission rate. It seems to be a trend that the mobile phone will be a personal information device, which stores a variety of utilities, including software, applications, and information. Thus it is worth exploring how to back up the information for mobile devices.

Typical backup solutions for mobile devices are aimed at mobile phones, which are most widely used nowadays. In a mobile phone, a built-in memory or a SIM card stores a directory of phone numbers, which can be further uploaded to a personal computer (PC) or a PDA via the infrared (IR) transmission or transmission wires. For example, a Nokia 7650 phone uses IR transmission or “Bluetooth” technology to transfer and back up information into a personal computer. The PenPower Technology Ltd in Taiwan provides software for such purposes.

Since not all mobile phones support IR transmission, Bluetooth technology, or wired transmission, SIM card reading devices are introduced for transferring the information recorded in the SIM card to the PC. For example, iNEX Technology's SIM Master is a product of this category.

The backup solutions of mobile devices use the IR transmission, Bluetooth technology, and the wired transmission to transfer information of a mobile device to a storage device. For example, it is well known that a PDA and a PC can synchronize their data via the wire connection between them.

In general, backup solutions of mobile communication devices now utilize external transmission modules, rather than the built-in communication module within the mobile communication device. For example, the built-in communication module of a mobile phone operates with a GSM network or a PHS network. In comparison, using IR transmission, Bluetooth technology, or wired transmission to transfer information in a mobile phone to a storage device complicates the design and increases the cost. Moreover, IR transmission, Bluetooth technology, and wired transmission all have distance limitations, which degrade the mobility of mobile devices.

Mobile communication devices are going to be “personal information devices” according to the trend. Accordingly, a backup system of mobile communication devices will evolve into a “personal information database”. A powerful backup system of mobile devices needs to communicate data with other mobile devices and other personal information databases. To achieve this objective, the backup systems or the personal information databases should be placed in an “open” architecture, such as the Internet or a GSM network. In contrast, backup solutions of prior art are in a “close” architecture, in which data are only transferable between the backup system and the corresponding mobile device.

For the e-mail backup system, web-mail services such as “http://www.sinica.edu.tw/webmail” and “http://www.hotmail.com” are good examples. The e-mails are stored in a remote server instead of on the local client computer. One can upload or download e-mails via the Internet by using a browser such as Microsoft's Internet Explorer.

Therefore, a backup system for mobile devices will be advantageous if it can work without external communication modules and the restriction of distance limitations. Furthermore, it will be more advantageous if the backup system can be expanded to be a personal information database.

### SUMMARY OF THE INVENTION

It is an object of the present invention to provide a backup system for backing up information of mobile devices via wireless communication.

It is another object of the present invention to provide a backup system for synchronizing the information in a remote server and in local clients via wireless communication.

It is yet another object of the present invention to provide a backup system for synchronizing the information among a server and a number of mobile phones via a mobile phone network.

The present invention uses the wireless communication features embedded in a mobile device to back up the information in a server. Therefore the present invention uses an existing communication network (e.g. a GSM network) to access or back up information among several clients and a server.

The present invention provides a backup system for backing up information of mobile devices via wireless communication. The backup system includes a first mobile terminal, a backup server, and a transmission module. The first mobile terminal includes a first storage module for storing first information and a detection module. The backup server includes a server storage module for storing server information and a server detection module. The transmission module provides data transmission between the first mobile terminal and the backup server. Through the transmission module, a copy of first information is uploaded to the backup server as the server information, or a copy of server information is downloaded to the first mobile terminal as the first information. That is, the first information and the server information are initially made identical. Then, selectively, when the detection module detects an alteration of the first information, the first mobile terminal requests the backup server to correspondingly alter the server information; when the server detection module detects an alteration of the server information, the backup server requests the first mobile terminal to correspondingly alter the first information.

The present invention also discloses a method for backing up information of mobile devices via wireless communication by a system. The system includes a first mobile terminal and a backup server. The first mobile terminal is provided for storing first information, and the backup server is provided for storing server information. The method includes: (a) selectively performing: (a1) uploading a copy of first information to the backup server as the server information, and (a2) downloading a copy of server information to the first mobile terminal as the first information. After step (a), it goes to step (b): selectively performing: (b1) when an alteration of first information occurs, correspondingly altering the server information; and (b2) when an alteration of server information occurs, correspondingly altering the first information.

The present invention further discloses a mobile terminal in a system. The system backs up information of the mobile terminal via wireless communication. The system includes a backup server. The mobile terminal includes a storage module, a transmission module, and a detection module. The storage module is provided for storing the information. The transmission module is provided for data transmission between the mobile terminal and the backup server, whereby a copy of the information is uploaded to the backup server. The detection module is provided for detecting an alteration of information. When the detection module detects the alteration of information, the backup server is requested to alter the copy of the information.

### BRIEF DESCRIPTION OF THE DRAWINGS

For a more detailed understanding of the present invention, reference is now made to the following descriptions taken in conjunction with the accompanying drawings. The same notation number in FIG. 1 and FIG. 2 represents elements of the same function.

FIG. 1 is a block diagram illustrating a backup system according to an embodiment of the present invention;

FIG. 2 is a block diagram illustrating a backup system according to another embodiment of the present invention;

FIG. 3 is a flowchart illustrating a method according to an embodiment of the present invention; and

FIG. 4 is a flowchart illustrating a method according to another embodiment of the present invention.

### DETAILED DESCRIPTION

The present invention may be described herein in terms of various functional components and various processing steps. It should be appreciated that such functional components may be realized by a variety of different hardware or structural components configured to perform the specified functions. For purposes of illustration only, exemplary embodiments of the present invention will be described herein. Further, it should be noted that, while various components may be suitably coupled, connected, or linked to other components, such links, connections, and couplings may be realized by a direct connection between components, or by a connection through other components and devices.

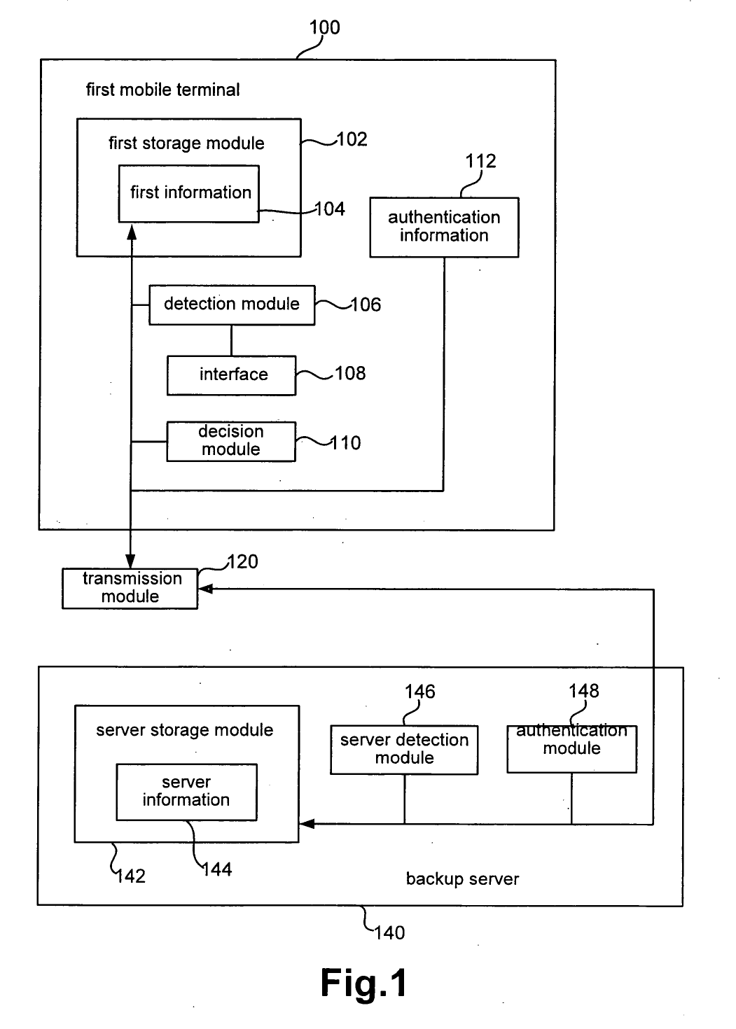

FIG. 1 is a block diagram illustrating a backup system according to an embodiment of the present invention. The backup system includes a first mobile terminal 100, a transmission module 120, and a backup server 140. The first mobile terminal 100 can be a mobile phone, a PDA, a laptop, or any device having the capabilities of wireless communication and data storage. The transmission module 120, for example, uses a GSM network, a PHS network, Bluetooth technology, WLAN, or Infrared-Ray transmission to wirelessly connect the first mobile terminal 100 and the backup server 140. The backup server 140 is implemented as a typical computer with any suitable operating systems such as Windows 95, Windows 98, Windows NT, Windows 2000, Windows XP, Linux, FreeBSD, AIX, UNIX, MacOS, Solaris, IBM OS/400 and the like, which are known to those skilled in the art.

The first mobile terminal 100 includes a first storage module 102 for storing first information 104. The backup server 140 includes a server storage module 142 for storing server information 144. Through the transmission module 120, a copy of first information 104 is uploaded to the backup server 140 as the server information 144, or a copy of the server information 144 is downloaded to the first mobile terminal 100 as the first information 104. As a result, the first information 104 and the server information 144 are initially made identical. In this manner, a user can back up the first information 104 and retrieve it from the backup server 140 when needed.

For example, the first mobile terminal 100 is a mobile phone, and the first information 104 is a directory of phone numbers. Via a mobile phone network (e.g., a GSM network), a copy of the directory of phone numbers 104 is uploaded to the backup server 140 as the information 144. When the directory of phone numbers 104 has been deleted or lost in the first mobile terminal 100, or when the user uses another mobile terminal, he can retrieve the directory of phone numbers 144 from the backup server 140.

The first mobile terminal 100 includes a detection module 106 for detecting an alteration of first information 104. The backup server 140 includes a server detection module 146 for detecting an alteration of server information 144. After the first information 104 and the server information 144 are initially made identical, when the detection module 106 detects the alteration of first information 104, the first mobile terminal 100 requests the backup server 140 to correspondingly alter the server information 144; or when the server detection module 146 detects the alteration of server information 144, the backup server 140 requests the first mobile terminal 100 to correspondingly alter the first information 104. As a result, the first information 104 and the server information 144 are both updated at the same time.

The first mobile terminal 100 further includes an interface 108 coupled to the detection module 106. When the detection module 106 detects the alteration of first information 104, the user uses the interface 108 to acknowledge the alteration of first information 104 and to allow the server information 144 to be altered by the backup server 140. The interface 108 is further linked to the server detection module 146 via the transmission module 120. When the server detection module 146 detects the alteration of server information 144, the user uses the interface 108 to acknowledge the alteration of server information 144 and to allow the first information 104 to be altered by the first mobile terminal 100. Those skilled in the art should understand that the interface 108 includes a man-machine interface, such as a keyboard and a monitor, provided for the user to input commands of selection and confirmation.

In one embodiment, the first information 104 is a directory of phone numbers. The directory of phone numbers 104 at least includes a name and a phone number associated with the name, e.g., “ABC(name)-123(phone number)”. Accordingly, the server information 144 includes “ABC-123”. When “ABC-123” is revised as “ABC-124” (or “ABC-1234”) at the first mobile terminal 100, the detection module 106 detects the alteration of first information 104. Then the first mobile terminal 100 requests the backup server 140 to correspondingly alter the server information 144, that is, to revise “ABC-123” to “ABC-124” (or “ABC-1234”) at the backup server 140. Vice versa, when “ABC-123” is revised as “ABC-124” (or “ABC-1234”) at the backup server 140, the server detection module 146 detects the alteration of server information 144. Then the backup server 140 requests the first mobile terminal 100 to correspondingly alter the first information 104, that is, to revise “ABC-123” to “ABC-124” (or “ABC-1234”) at the first mobile terminal 100. It should be noted that the backup server 140 further connects to other peripheral devices, such as a keyboard or a data input devices, for the user to revise the server information 144. The backup server 140 can connect to other peripheral devices directly or via a network, such as the Internet.

It should also be noted that, after the alteration of first information 104 or of the information 144 is detected, only data segments about the alteration, instead of the whole revised information, need to be transferred for the corresponding alteration of the information 144 or of the first information 104. This manner can increase the transmission efficiency.

In addition to the directory of phone numbers, the first information 104 and the information 144 can be implemented as an address book, a calendar, an agenda, a text message, a multimedia message, a piece of text information, a piece of multimedia information, an application program, or other personal information. In one embodiment, the detection module 106 detects the alteration based on when the information was most recently saved, e.g., by comparing the most recent time the first information 104 is saved. In another embodiment, the detection module 106 detects the alteration by comparing how much storage space the first information 104 needs. Likewise, the server detection module 146 can detect the alteration based on when the server information 144 was most recently saved or how much storage space the server information 144 needs. In yet another situation, after the first information 104 and the information 144 are initially made identical, both of them encounter respective alterations. The detection module 106 and the server detection module 146 compare the time when the first information 104 is altered and the time when the server information 144 is altered, and performs subsequent procedures based on the more recent change.

The first mobile terminal 100 includes a decision module 110 for the user to decide whether to upload the copy of first information 104 to the backup server 140, or to decide whether to download the copy of server information 144 to the first mobile terminal 100. For example, the first mobile terminal 100 is a mobile phone, and the user creates a directory of phone numbers 104. The user can use the decision module 110 to decide whether to upload a copy of the directory of phone numbers 104 to the backup server 140. When the directory of phone numbers 104 on the mobile phone 100 is deleted or lost, the user can use the decision module 110 to decide whether to retrieve the copy of the directory of phone numbers 104 from the backup server 140. Those skilled in the art should understand that the decision module 110 includes a man-machine interface, such as a keyboard and a monitor, provided for the user to input commands of selection and confirmation.

The first mobile terminal 100 further has authentication information 112, and the backup server 140 further includes an authentication module 148. If the authentication module 148 authenticates the authentication information 112, it is allowable to upload the copy of first information 104 to the backup server 140, or to download the copy of server information 144 to the first mobile terminal 100. For example, the first mobile terminal 100 is a mobile phone, and the authentication information 112 is an SIM (Subscriber Identity Module) code, an IEMI (International Mobile Equipment Identity) code, or a PIN (Personal Identification Number).

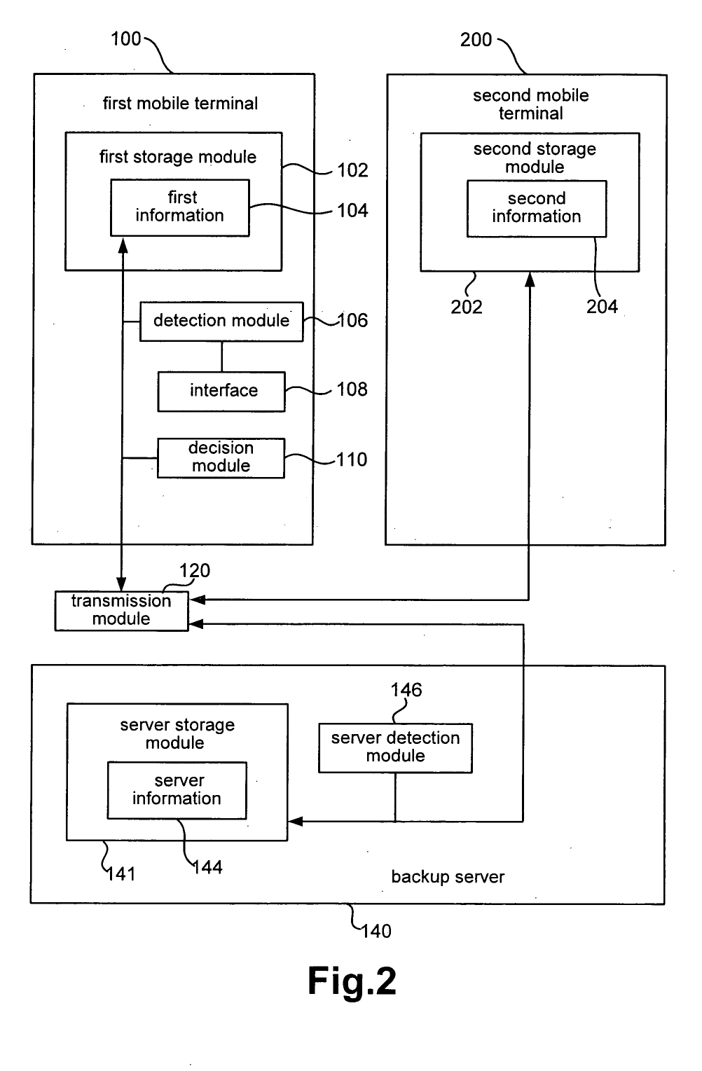

FIG. 2 is a block diagram illustrating a backup system according to another embodiment of the present invention. The backup system further includes a second mobile terminal 200. The second mobile terminal 200 can be a mobile phone, a PDA, a laptop, or any device having the capabilities of wireless communication and data storage. The transmission module 120 further wirelessly connects the backup server 140 and the second mobile terminal 200. The second mobile terminal 200 includes a second storage module 202 for storing the second information 204. Through the transmission module 120, the copy of the server information 144 is downloaded to the second mobile terminal 200 as the second information 204. As a result, the first information 104, the server information 144, the second information 204 are initially made identical. In this manner, a user can back up the first information 104 and retrieve it at the second mobile terminal 200.

In one embodiment, the second mobile terminal 200 is implemented as a PDA, and the first mobile terminal 100 is implemented as a mobile phone. The first information 102 is a calendar. Via a GSM network, one uploads a copy of the calendar 102 to the backup server 140, and downloads the copy of the calendar to the PDA 200. In another embodiment, the second mobile terminal 200 is also implemented as a mobile phone. The first information 104 is a directory of phone numbers. Therefore, a copy of the directory of phone numbers 104 can be acquired at the mobile phone 200 via the backup server 140, compared with the related art in which the directory of phone number 104 needs to be input manually at the mobile phone 200.

Moreover, after the first information 104, the information 144, and the second information 204 are initially made identical, when the detection module 106 detects the alteration of first information 104, first mobile terminal 100 informs the backup server 140 to correspondingly alter the server information 144. And then the server detection module 146 detects the alteration of the information 144 and requests the second mobile terminal 200 to correspondingly alter the second information 204. As a result, the first information 104, the server information 144, and the second information 204 are all updated. The interface 108 is further provided for the user to allow the second information 204 to be altered by the second mobile terminal 200.

In an embodiment, both the first mobile terminal 100 and the second mobile terminal 200 are implemented as PDAs with wireless communication features. The first information 104 is an agenda. The agenda 104 at least includes an event and a time associated with the event, e.g. “interview(event)-3pm(time)”. At the same time, both the server information 144 and the second information 204 include “interview-3pm”. When “interview-3pm” is revised as “interview-4pm” at the first mobile terminal 100, the detection module 106 detects the alteration of first information 104. Then the first mobile terminal 100 requests the backup server 140 to correspondingly alter the server information 144, that is, to revise “interview-3pm” to “interview-4pm” at the backup server 140. Next, the server detection module 146 detects the alteration of server information 144. The backup server 140 requests the second mobile terminal 200 to correspondingly alter the second information 204, that is, to revise “interview-3pm” to “interview-4pm” at the second mobile terminal 200.

The decision module 110 in FIG. 2 is further provided for the user to decide whether to upload the copy of first information 104 to the backup server 140 and then download it to the second mobile terminal 200.

In another embodiment, both the first mobile terminal 100 and the second mobile terminal 200 are implemented as PDAs with wireless communication features. The server information 144 is an agenda. The agenda 144 at least includes an event and a time associated with the event, e.g. “meeting(event)-3pm(time)”. At the same time, both the first information 104 and the second information 204 include “meeting-3pm”. The backup server 140 further connects to other peripheral devices for the user to revise the server information 144. It should be noted that the backup server 140 can connect to other peripheral devices directly or via a network, such as the Internet. When “meeting-3pm” is revised as “meeting-4pm” at the backup server 140, the server detection module 146 detects the alteration of the information 144. Then the backup server 140 requests respectively the first mobile terminal 100 and the second mobile terminal 200 to correspondingly alter the first information 104 and the second information 204, that is, to revise “meeting-3pm” to “meeting-4pm” at the first mobile terminal 100 and at the second mobile terminal 200.

The backup system shown in FIG. 1 or FIG. 2 may include a computer program product usable with a programmable computer having computer readable program code embodied therein, the computer program product including computer readable program code that operates a computer processor. The computer program product may be provided in a fixed or removable memory, such as a ROM, PROM, disk drive or diskette, associated with the processor, and may be stored as a part of a databases associated with the processor, or may be supplied externally, as known to those of skilled in the art.

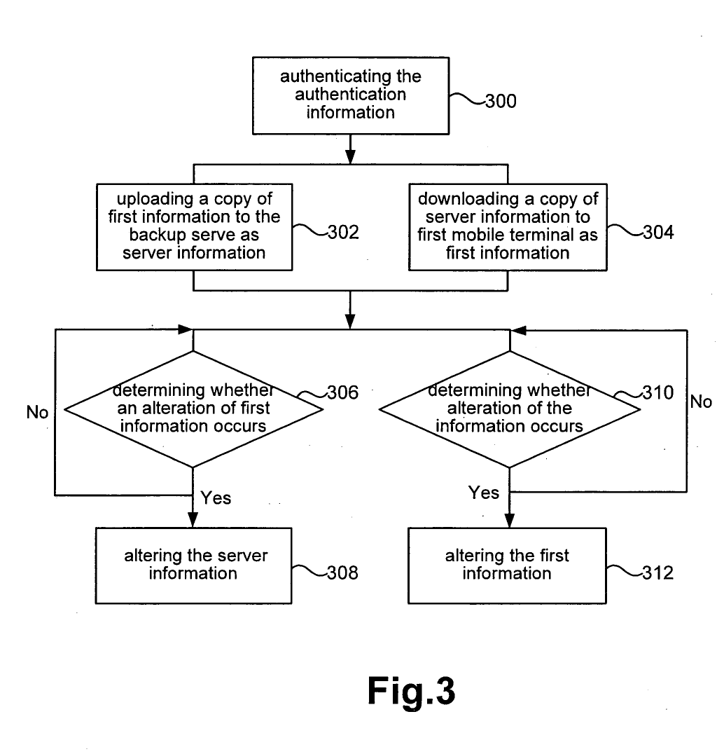

FIG. 3 is a flowchart illustrating a method according to an embodiment of the present invention, and the embodiment is described below with reference to the elements in FIG. 1. First, the step 300 is to authenticate the authentication information 112 of the first mobile terminal 100. After authentication, selectively, it goes to the step 302 and the step 304. The step 302 is to upload a copy of the first information 104 to the backup server 140 as the server information 144. The step 304 is to download a copy of server information 144 to the first mobile terminal 100 as the first information 104. Next, selectively, it proceeds with the step 306 and step 310. The step 306 is to determine whether an alteration of the first information 104 occurs, and if yes, it goes to the step 308: correspondingly alter the server information 144. The step 310 is to determine whether an alteration of the information 144 occurs, and if yes, it goes to the step 312: correspondingly alter the first information 104.

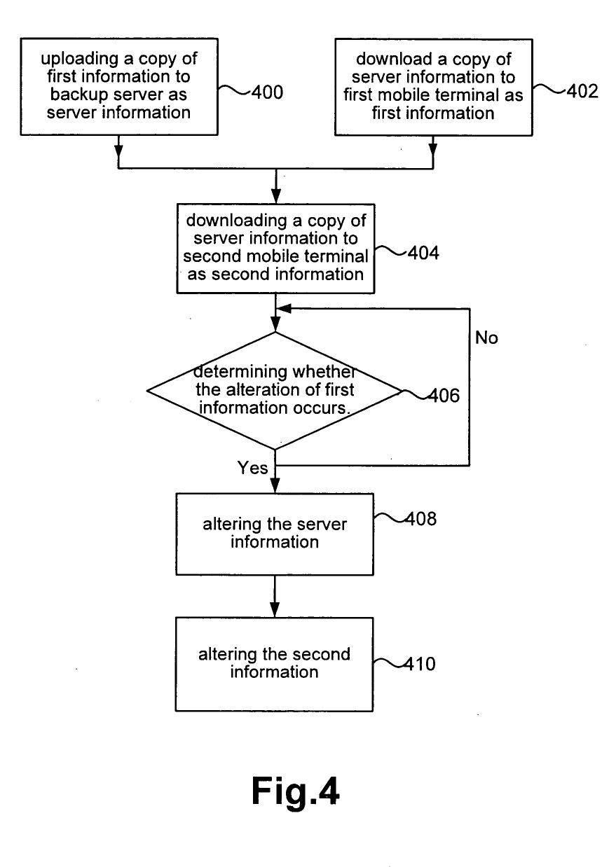

FIG. 4 is a flowchart illustrating a method according to another embodiment of the present invention, and the embodiment is described below with reference to the elements in FIG. 2. Selectively, it starts with the step 400 and the step 402. The step 400 is to upload the copy of the first information 104 to the backup server 140 as the server information 144. The step 402 is to download the copy of server information 144 to the first mobile terminal 100 as the first information 104. Next, it goes to the step 404: downloading the copy of server information 144 to the second mobile terminal 200 as the second information 204. Then it goes to the step 406: determining whether the alteration of first information 104 occurs. If yes, the step 408 is to correspondingly alter the server information 144, and the step 410 is to correspondingly alter the second information 204.

As will be appreciated by one of ordinary skill in the art, the present invention may be embodied as a method, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium Any suitable computer-readable storage medium may be utilized, including hard disks, CD-ROM, optical storage devices, magnetic storage devices, and/or the like.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A system for backing up information of mobile devices via wireless communication, said system comprising:
a first mobile terminal, comprising:
a first storage module for storing first information; and
a detection module;
a backup server, comprising:
a server storage module for storing server information; and
a server detection module; and
a transmission module providing data transmission between said first mobile terminal and said backup server, whereby a copy of first information is uploaded to said backup server as said server information, or a copy of server information is downloaded to said first mobile terminal as said first information, such that said first information and said server information are identical;
wherein, selectively,
when said detection module detects an alteration of first information, said first mobile terminal requests said backup server to correspondingly alter said server information; and
when said server detection module detects an alteration of server information, said backup server requests said first mobile terminal to correspondingly alter said first information.

2. The system as claimed in claim 1, said backup server further comprising an authentication module, said first mobile terminal further having authentication information;
wherein, if said authentication module authenticates said authentication information, said copy of first information being uploaded to said backup server as said server information or said copy of server information being downloaded to said first mobile terminal as said first information is allowable.

3. The system as claimed in claim 1, wherein said first mobile terminal further comprises a decision module for a user to decide whether to upload said copy of first information to said backup server, or to decide whether to download said copy of server information to said first mobile terminal.

4. The system as claimed in claim 1, said first mobile terminal further comprises an interface coupled to said detection module;
wherein, when said detection module detects said alteration of first information, a user uses said interface to acknowledge said alteration of first information and to allow said server information to be altered by said backup server.

5. The system as claimed in claim 4, said interface is further linked to said server detection module;
wherein, when said server detection module detects said alteration of server information, said user uses said interface to acknowledge said alteration of server information and to allow said first information to be altered by said first mobile terminal.

6. The system as claimed in claim 1, further comprising:
a second mobile terminal comprising second storage module for storing second information;
wherein said transmission module further provides data transmission between said second mobile terminal and said backup server, whereby said copy of server information is further downloaded to said second mobile terminal as said second information, such that said first information, said server information, and said second information are identical;
wherein, when said server detection module detects said alteration of said server information, said backup server requests said second mobile terminal to correspondingly alter said second information.

7. The system as claimed in claim 6, wherein said first mobile terminal further comprises a decision module for a user to decide whether to download said server information to said second mobile terminal.

8. The system as claimed in claim 6, said first mobile terminal further comprises an interface coupled to said detection module and linked to said server detection module via said transmission module;
wherein, when said detection module detects said alteration of first information, a user uses said interface to acknowledge said alteration of first information and to allow said server information to be altered by said backup server; said user further uses said interface to allow said second information to be altered by said second mobile terminal.

9. The system as claimed in claim 1, wherein said first mobile terminal is a mobile phone.

10. The system as claimed in claim 1, wherein said first information or said server information is selected from the group consisting of a directory of phone numbers, a calendar, an agenda, a test message, a multimedia message, a piece of text information, a piece of multimedia information, and a computer code segment.

11. The system as claimed in claim 1, wherein said transmission module provides data transmission between said first mobile terminal and said backup server via a mobile phone network.

12. A method for backing up information of mobile devices via wireless communication by a system, said system comprising a first mobile terminal and a backup server, said first mobile terminal storing first information, said backup server storing server information, said method comprising:
(a) selectively performing:
(a1) uploading a copy of first information to said backup server as said server information; and
(a2) downloading a copy of server information to said first mobile terminal as said first information; and
(b) selectively performing:
(b1) when an alteration of first information occurs, correspondingly altering said server information; and
(b2) when an alteration of server information occurs, correspondingly altering said first information.

13. The method as claimed in claim 12, said first mobile terminal further having authentication information, prior to the step (a) said method further comprising:
authenticating said authentication information.

14. The method as claimed in claim 12, said system comprising a second mobile terminal, said method comprising:
(c) downloading said copy of server information to said second mobile terminal; and
(d) when said alteration of said server information occurs, correspondingly altering said second information.

15. A mobile terminal in a system, said system backing up information of said mobile terminal via wireless communication, said system comprising a backup server, said mobile terminal comprising:
a storage module for storing said information;
a transmission module providing data transmission between said mobile terminal and said backup server, whereby a copy of information is uploaded to said backup server; and
a detection module for detecting an alteration of information;
wherein, when said detection module detects said alteration of information, said mobile terminal requests said backup server to correspondingly alter said copy of information.

16. The mobile terminal as claimed in claim 15, wherein said transmission module provides data transmission between said mobile terminal and said backup server via a mobile phone network.

17. The mobile terminal as claimed in claim 15, further comprising a decision module for a user to decide whether to upload said copy of information to said backup server.

18. The mobile terminal as claimed in claim 15, further comprising an interface for a user to acknowledge said alteration of information and to allow said copy of information to be altered by said backup server.

19. The mobile terminal as claimed in claim 15, wherein said detection module detects said alteration of information based on when said information was most recently saved.

20. The mobile terminal as claimed in claim 15, wherein said detection module detects said alteration of information based on how much storage space said information needs.
